(19) United States
(12) Patent Application Publication
(10) Pub. No.: US 2016/0235079 A1
(43) Pub. Date: Aug. 18, 2016

(54) Disposable Wood Smoker and Moisturizer for Residential Outdoor Cooking Grills

(71) Applicant: Melvin Ray Singleterry, Oviedo, FL (US)

(72) Inventor: Melvin Ray Singleterry, Oviedo, FL (US)

(21) Appl. No.: 14/622,877

(22) Filed: Feb. 15, 2015

(51) Int. Cl. A23B 4/052

(52) U.S. Cl. CPC A23B 4/0523; A23V 2002/00

(57) ABSTRACT

An enclosed disposable device for use on residential outdoor cooking grills that operates for an extended period of time, maintaining a low temperature environment within the internal cooking chamber that possesses external adjustable smoke exhaust ports and an internal liquid chamber for infusing meat, and other foods with smoke, other flavors, and moisture, while restricting contamination from wood fly ash, wood bits, and other carbon particulate.

### CROSS-REFERENCE TO RELATED APPLICATIONS

Provisional Patent Application No. 61/966,358 filed Feb. 22, 2014; Confirmation No. 8373

### TECHNICAL FIELD

This invention is a disposable device for use in residential outdoor cooking grills that infuses wood smoke, other flavors, and moisture into meat and other food.

### BACKGROUND OF INVENTION

Backyard cooking and grilling is a popular endeavor practiced by thousands of people. For many this activity is not limited to simply cooking a piece of meat or other food on a hot grill, it involves some kind of process in an attempt to infuse meat and other food with a smoked flavor. The process involves burning wood chips in close proximity to food within the confines of an enclosed cooking grill. The heat source in the grill can be generated by burning gas, using electricity, or by burning charcoal.

The process of smoking food, when attempted by use of a charcoal, gas, or electric grill with the present state of the art devices, has drawbacks and limitations. It is more a cooking and searing operation rather than it is in infusing the food with a smoked flavor. With the charcoal grill, wood chips are placed directly on ignited charcoal bricketts. With the gas or electric grills, wood chips are placed in a metallic box positioned above a lighted gas or electric grill burner. In both instances the wood chips have a tendency to ignite, flame and burn rather than smolder and produce smoke. Continual addition of wood chips is required. Excessive heat is produced and food will be cooked before it can be infused with smoke flavor. Smoke penetration into the food is difficult. At best, the smoked flavor will be superficial. Proper infusion of smoke, other flavors, and moisture into meat requires that the food be placed in close proximity to a smoke and moisture source in an enclosed space for an extended period of time. The temperature within the enclosed space must be low to avoid premature cooking of the meat.

In none of the smoking devices available for use on charcoal, gas, or electric grills can the smoke volume and the air intake be precisely regulated; consequently, the time required to infuse smoke into the food and the intensity of the smoked flavor cannot be adequately controlled. Moreover, because the present available devices are typically not sealed units they do not contain a mechanism for regulating the chimney effect. Without a regulating mechanism air intake is accelerated causing burning and flame out without allowing the wood to smolder and produce smoke.

Present available devices are designed to burn wood chips or shavings rather than large wood chunks. Wood chips and shavings burn rapidly and produce heat rather than smoke, whereas, large wood chunks burn slowly, without flame, smolder and produce smoke.

Present available devices constituting the prior art do not have a suitable internal mechanism to dispel moisture and/or different flavoring agents into the cooking environment. Without adding moisture into the interior of the grill, the meat food product produced will be dry, devoid of flavor, and tough.

Present available devices are not designed to prohibit wood ash and carbon particle contamination of the interior of the cooking grill and the food located there in. Wood chips and shavings produce considerably more fly ash and carbon particles than do large wood chunks. Moreover, present available devices do not contain any screening or filter mechanism to inhibit expulsion of wood fly ash or other carbon particles into the interior of the cooking grill.

Present devices are typically made of cast iron or some type of steel, consequently they are not disposable after use requiring that they cleaned and stored.

### BRIEF SUMMARY OF INVENTION

In order to provide a device that addresses the limitations of smoking devices that constitute the present state and that provides a superior method for infusing smoke, moisture, and other flavors into meat, seafood, and other food on residential gas, electric, and charcoal grills, this device has been developed. The device is a closed container made of heavy gage aluminum foil sheeting that contains specific sized and placement of wood chunks. The device is placed on the cooking grate above a heat source inside a residential outdoor cooking grill, thereby converting the grill into a “smoker”.

It is thus an object of the present invention to provide a smoker that is functional, economical, safe, easy to use, and that is disposable after use.

It is thus an object of the present invention to provide a smoker device that causes deep infusion of smoked flavor into food rather than only superficial addition of such flavor.

It is another object of the present invention to provide a smoker device that contains an internal water/liquid chamber used for holding liquids that when heated produces steam, vapor, and moisture that migrates throughout the interior of the grill causing the food to be tender, moist and flavorful.

It is another object of the present invention to provide a smoker device used for smoking food, wherein the volume of smoke, the time required, the intensity of smoked flavor, and the depth of smoke flavor penetration into the food can be accurately regulated.

It is another object of the present invention to provide a smoker device used for smoking meat and other food to provide a mechanism to prohibit the internal combustible material from flaming and producing excess heat rather than smoldering and producing smoke.

It is another object of the present invention to produce a smoker device used for smoking food that provides a means to alter the flavor of foods through the addition of flavoring agents such as fruit juice, cider, beer, wine, or other spirits into the internal water/liquid chamber.

It is another object of the present invention to provide a means for adjusting the amount of moisture emitted into the interior chamber of the cooking grill.

It is another object of the present invention to produce a smoker device that will produce smoke and vapor for an extended period of time that is essential for proper infusion of flavor and moisture into the food.

It is another object of the present invention to produce a smoker device that permits the interior grill temperature to remain low while a high volume of smoke and moisture is generated. Food will not be seared or cooked before it is sufficiently smoked.

It is another object of the present invention to provide a smoker device that accommodates large wood chunks rather than just wood chips and shavings, thereby reducing the necessity of continually adding combustible material, negating the tendency of producing flame and excess heat rather than smoke, and reducing the amount of wood fly ash generated.

It is another object of the present invention to provide a smoker device that produces smoke without emission of wood fly ash and other contaminates into the interior of the cooking grill chamber.

It is another object of the present invention to provide a smoker device that is disposable after use and does not have to be cleaned or stored.

Other objects, features, and advantages of the smoker device will become apparent from the following description, taken in conjunction with the appended drawing figures.

### BRIEF DESCRIPTION OF THE SEVERAL VIEWS OF THE DRAWINGS

FIG. 1 is a perspective view of the preferred embodiment of the smoker device;

FIG. 2 is an exploded perspective view of the preferred embodiment of the smoker device illustrating the 6 primary components and their geometric placement;

FIG. 3 is a perspective cut away view of the smoker device illustrating the number and geometric placement of the bottom air and flame intake ports as well as the placement of the internal liquid chamber;

FIG. 4 is a perspective view of the embodiment of the smoker device illustrating the inclusion of wood chunks.

### DETAILED DESCRIPTION OF THE INVENTION

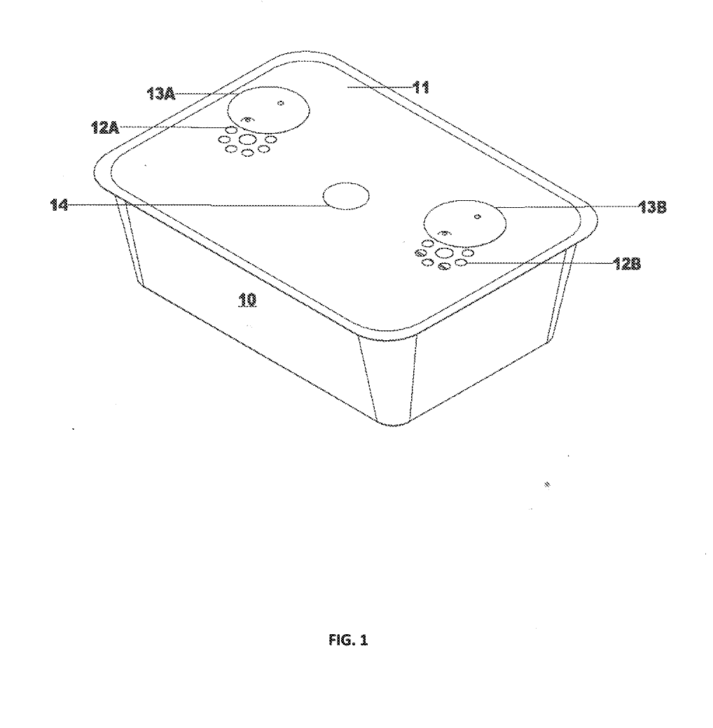

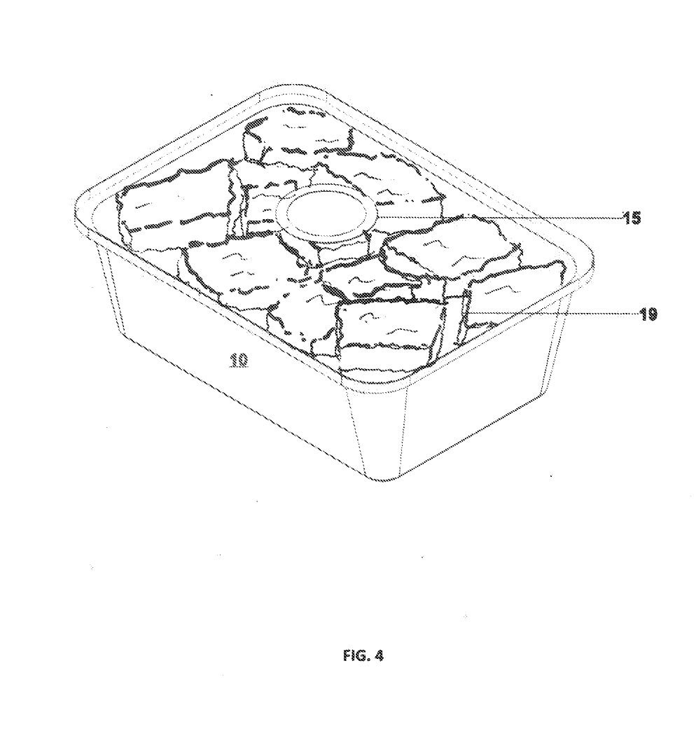

The present invention as shown in FIG. 1 is a disposable device capable of producing smoke and moisture for infusion of smoke, other flavors, and moisture into meat and other food when used in conventional residential gas, charcoal, or electric cooking grills. As illustrated in FIG. 4, numeral 19, an assortment of large wood chunks are used as the combustible smoke flavor producing material. The species of the wood from which the wood chunks are made are hard woods and fruit woods. Prior to use, the entire smoker device, including its combustible contents, is immersed in water for at least two hours. The device is disposed on a cooking grate, above a heat source, within the confines of the cooking grill. Food to be smoked is placed on the cooking grates within the grill chamber. After ignition of the combustible material inside the device, the grill cover is closed. While the interior temperature of the grill remains relatively low, the smoker device will emit smoke, other flavors and moisture into the interior of the cooking grill for up to 7 hours. Proper smoking, flavoring, and moisturizing can only be performed by exposing meat and other food to a smoke and moisture source at a low temperature for an extended period of time. High heat results in searing the exterior of the meat and causes it to be cooked before it is sufficiently smoked. Grill cooked, seared meat will not absorb smoke, smoke flavor, or moisture as the cooking and searing process, by its very nature, extracts moisture and liquid naturally imbedded into the meat fibers and causes the molecules to shrink and adhere to each other. Less void space between the fibers and molecules restrict the amount of moisture and flavor that can be absorbed.

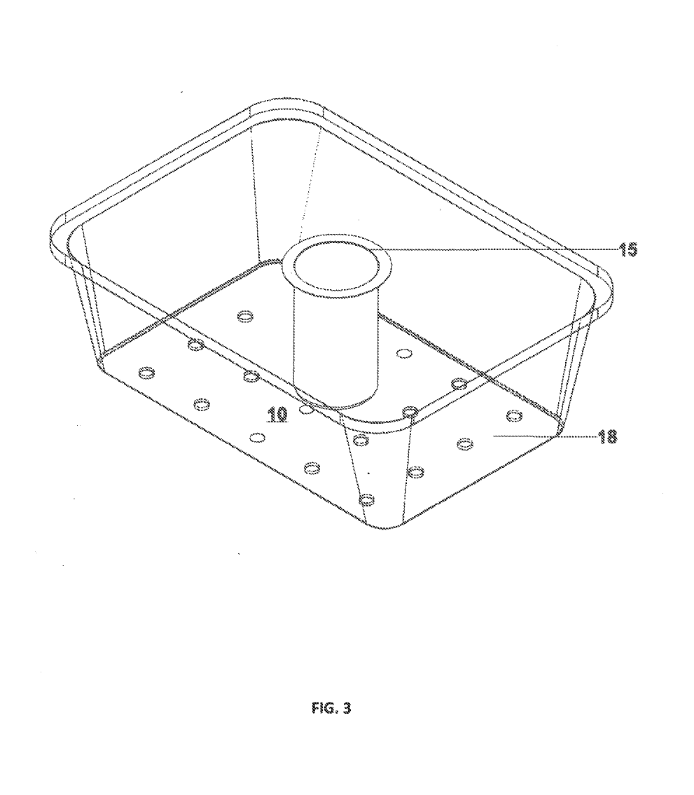

The preferred embodiment of the smoker device at FIG. 1 is a sealed unit that is comprised of a rectangular-shaped receptacle 10 made of thick gage aluminum foil sheet possessing a fold over rim that is used to attach a lid 11. Depicted at FIG. 1 and FIG. 3 at numeral 18, are a series of 20 spaced ⅜ inch holes located in the bottom of the container, 10 that serve as portals for the intake of air and heat from the lighted grill fuel source.

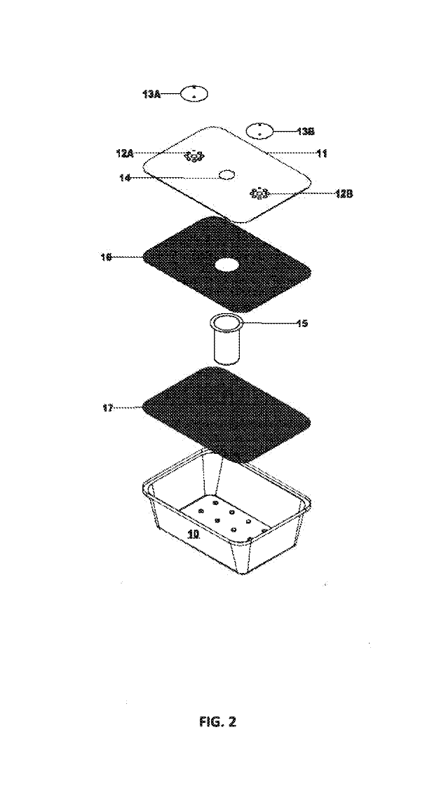

The lid as shown in FIG. 1 and FIG. 2 at numeral 11 is made of thick gage aluminum foil sheet. Cut into the lid, 11 as depicted on FIG. 1, FIG. 2, are two sets of smoke exhaust ports composed of 8 holes each 12A, 12B. Attached adjacent to each of the 2 smoke exhaust ports are two small covers 13A, 13B made of aluminum sheet. These covers are attached in such a way that they can be slid with the use of a meat fork back and forth over the exhaust ports thereby providing a means to regulate air intake from the 20 apertures located in the bottom of the container 10, FIG. 2 and FIG. 3, numeral 18 and to adjust the volume of smoke emitted into the interior of the grill. In the center of the lid 11 is an inverted cone shaped port, FIG. 1, FIG. 2, and FIG. 3, number 14, located above the liquid cup 15, depicted at FIG. 2, FIG. 3, and FIG. 4 that serves as a portal for the addition of water and/or other liquids to add moisture and flavor to the food being smoked.

FIG. 2, is an exploded view of the embodiment of the smoker device showing the container, 10 with the bottom air intake apertures, numeral 18, the lower metal mesh screen, numeral 17, the upper mesh screen, numeral 16, that contains an aperture of sufficient size to accommodate the body of the cup, numeral 15, the lid 11 with the 2 sets smoke exhaust ports, 12A, 12B, the sliding lids 13A, 13B, and the center aperture, 14 used as a portal for the addition of liquids into the cup 15.

The upper metal mesh screen depicted in FIG. 2, numeral 16 serves as a barrier for inhibiting wood ash, wood particles, and other carbon particulate exiting the smoke portals, 12A, 12B and contaminating the grill chamber, as well as, the food being smoked.

The lower metal mesh screen depicted in FIG. 2, numeral, 17 serves as a barrier for wood ash, wood particles, and other carbon particulate from falling through the air intake portals 18 into the interior of the grill also causing contamination of the grill chamber and the food being smoked.

FIG. 2, FIG. 3 and FIG. 4 also depict the rimed cup 15 made of heavy duty aluminum foil sheet. The cup is located in the center of the container 10, and is disposed on top of the bottom screen mesh 17, and is located directly under the liquid portal 14 located in the center of the lid, 11. The cup is disposed through the center portal in the top screen mesh 16. It adjoins the bottom of the lid 11 at the cup rim located on the top exterior of the cup 15. The cup 15 serves as a container for holding water, that when heated from the grill heat source, produces steam, vapor, and, moisture that is expelled into the interior of the cooking grill chamber. The addition of the steam and moisture generated from the water in the cup into the cooking grill chamber causes the food being smoked to be moist, tender, and supple. The flavor of the food being smoked can be altered and enhanced by the addition into the cup flavoring agents such as fruit juices, wine, beer, and other spirits. The amount of moisture emitted into the grill chamber can be regulated by adding or reducing of the amount of liquid introduced through the portal 14 and into the cup 15.

FIG. 4 shows an open view of the device and depicts the inclusion of large wood chunks that serves as the combustible material for producing wood smoke.

The smoker-moisturizing device and all components detailed at FIG. 1, FIG. 2, and FIG. 3 and FIG. 4 are all made of heavy gage aluminum foil sheet that has a high heat temperature tolerance. The device and all of its components easily withstand extreme temperatures created by direct contact with flame.

The device will not bend, warp, or burn. Since it is a closed device with the fuel source contained therein, additional combustible material never has to be added. It is disposable after use negating the necessity to clean and store.

1. A long burning, disposable smoker and food moisturizing device for use in residential outdoor cooking grills comprised of a rectangular-shaped, enclosed container containing combustible material with two adjustable smoke exhaust ports, one internal liquid chamber, a vapor exit port, and two internal screen filters that when lighted produces smoke, other flavors, and moisture for infiltrating meat and other food placed within the cooking grill chamber.

2. A smoker device as noted in claim 1 that is a rectangular-shaped container comprising of longitudinal walls with opposing end walls and a bottom attached to said walls.

3. A smoker device as noted in claim 1, wherein said rectangular-shaped container is fabricated from heavy gage aluminum sheet possessing a high heat tolerance.

4. A smoker device as noted in claim 1, wherein said rectangular-shaped container possesses a top lid constructed of aluminum sheet that is attached to the container by a fold-over lip located around the top rim of the container.

5. A smoker device as noted in claim 1, wherein said top lid contains two sets of smoke exhaust ports each made up of 8 vent holes with a sliding lid attached at the side of each of the ports.

6. A smoker device as noted in claim 1, wherein said top lid contains an open inward cone shaped port wherein water and/or other liquids can be added to the internal liquid chamber and that serves as an exhaust portal for steam, moisture, and vapor.

7. A smoker device as noted in claim 1, wherein the container contains an aluminum sheet foil cup located just below the lid cone shaped port for the purpose of receiving and holding liquids that when heated causes steam and vapor to be expelled through the exhaust portal into the interior of the closed grill chamber.

8. A smoker device as noted in claim 1, wherein the container bottom contains a plurality of perforations serving as portals for heat and air induction.

9. A smoker device as noted in claim 1, wherein the container is a closed device and capable of holding wood chunks as the combustible material.

10. A smoker device as noted in claim 1, wherein the smoke exhaust ports contain a screen filter to prohibit wood ash from exiting the interior of the device causing wood ash contamination of the food and interior of the cooking grill.

11. A smoker device as noted in claim 1, wherein the bottom air and heat intake perforations are covered by a metal screen filter to reduce the amount of wood ash and solid carbon particles derived from the burned fuel source from falling into the interior of the cooking grill.
